(19) United States
(12) Patent Application Publication
(10) Pub. No.: US 2010/0332907 A1
(43) Pub. Date: Dec. 30, 2010

(54) SYSTEM AND METHOD FOR TESTING DIFFERENT COMPUTER TYPES

(75) Inventor: Yong-Zhao Huang, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/630,967

(22) Filed: Dec. 4, 2009

(30) Foreign Application Priority Data
Jun. 30, 2009 (CN) 200910303887.0

(51) Int. Cl. G06F 11/28

(52) U.S. Cl. 714/37; 714/E11.178

(57) ABSTRACT

A system and method for testing different computer types sets test parameters of each computer type of the computers, and sends a test command to each computer to control each computer to test each test signal of the computer. The system and method further receives test result data collected by the computer, and compares the test result data with preset standard test result to determine if the test result data is acceptable.

### BACKGROUND

1. Technical Field

Embodiments of the present disclosure relate to electronic device testing technology, and particularly to a system and method for testing different computer types.

2. Description of Related Art

Testing computer components is an important phase in the manufacturing process and is closely interrelated to product quality. Currently, testing computer components on a computer may be automatically processed on a production line. However, the current method cannot test different types of computers simultaneously. Therefore, prompt and accurate test of the components on different types of computers is desirable.

### BRIEF DESCRIPTION OF THE DRAWINGS

FIG. 1 is a block diagram of one embodiment of a test server comprising a system for testing different computer types.

FIG. 2 is a block diagram of one embodiment of function modules of a test server comprising a test system.

FIG. 3 is a flowchart of one embodiment of a method for testing different computer types.

### DETAILED DESCRIPTION

All of the processes described below may be embodied in, and fully automated via, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

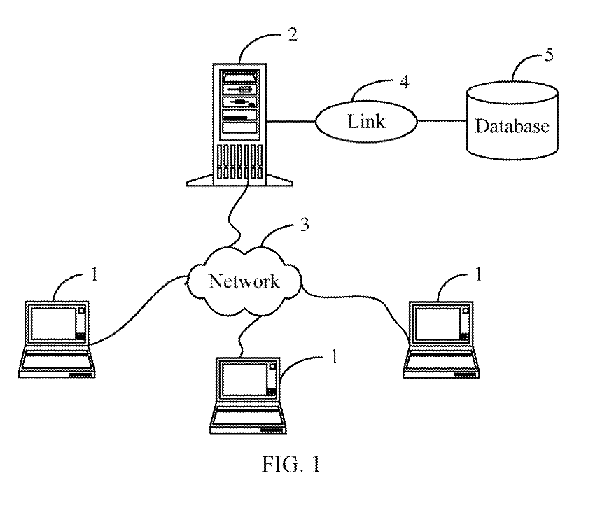

FIG. 1 is a block diagram of one embodiment of a test server 2 comprising a system for testing different types of computers. In one embodiment, the test server 2 is connected to a plurality of computers 1 (only three are shown) through a network 3. Each computer type of the plurality of computers may be different (e.g., different memory, memory systems, processors, for example). The test server 2 is further connected to a database 5 through a link 4. In one embodiment, the link 4 may be a database connectivity, and the database connectivity may be an open database connectivity (ODBC) or a Java database connectivity (JDBC) depending on the embodiment. In one embodiment, the number of the types of the plurality of computers 1 is greater than or equal to two, and the type of the plurality of computers 1 is determined by different models of the plurality of computers 1.

Referring to FIG. 1, the test server 2 may be used to test different computer types by setting test parameters of each computer type of the computers 1, and sending a test command to each of the computers 1 to control each the computer 1 to test each test signal of the computer. The plurality of computers 1 collects test result data of each test signal and sends the test result data to the test server 2. The test result data are compared with preset standard test result, so as to determine if the test result data are acceptable. A detailed description will be given in the following paragraphs.

In one embodiment, the database 5 may be used to store data, such as test parameters of each type of computers 1. In one embodiment, the test parameters may include computer types, test items of each computer type, a test signal sequence of each test item, a standard test result of each test signal in the test signal sequence, and a preset storage path to store test result data of each computer type. In other embodiments, the test parameters may be stored in other suitable storage device, such as a hard disk.

In one embodiment, the test items of each computer type may include a central processing unit (CPU), a compact disc read-only memory (CD-ROM), and a modem, and the test signals in the test signal sequence may include a voltage signal, a periodic signal, and/or a frequency signal, for example. For example, the test signals of the CPU may include an overshoot value of the voltage signal, an undershoot value of the voltage signal, a slew rate of the voltage signal, a rise time of the voltage signal, a fall time of the voltage signal, and a duty cycle distortion of the voltage signal.

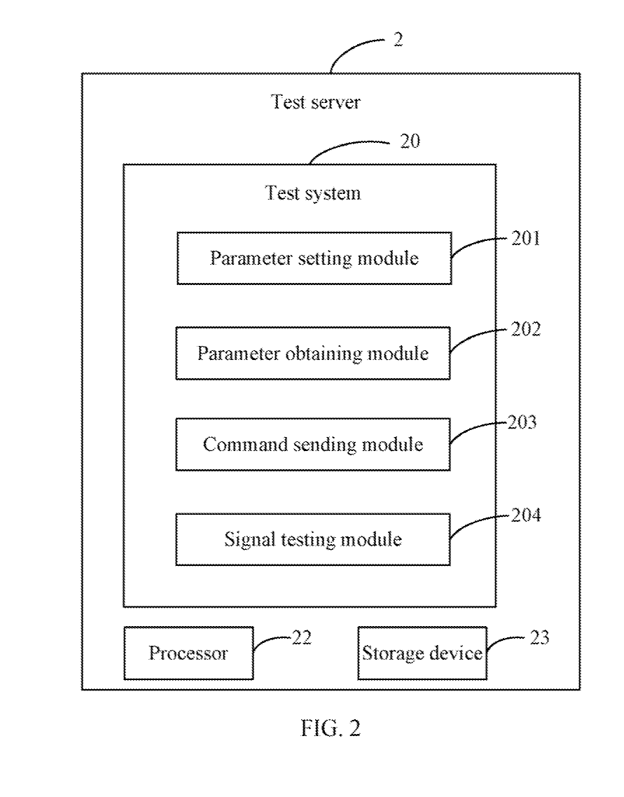

FIG. 2 is a block diagram of one embodiment of the test server 2 comprising a test system 20. In one embodiment, the test system 20 includes a parameter setting module 201, a parameter obtaining module 202, a command sending module 203, and a signal testing module 204. In one embodiment, the modules 201-204 comprise one or more computerized instructions that are stored in a storage device 23. A processor 22 of the test server 2 executes the computerized instructions to implement one or more operations of the test server 2.

The parameter setting module 201 sets test parameters of each computer type of the computers 1 and stores the test parameters in a storage device (e.g., the database 5) of the test server 2.

The parameter obtaining module 202 reads test parameters of each computer type of the computers 1 from the database 5.

The command sending module 203 sends a test command to each computer 1 according to the test parameters of each computer type. In one embodiment, the test command includes the test items of each computer type, the test signal sequence of each test item, the standard test result of each test signal in the test signal sequence, and the preset storage path to store test result data of each computer type.

The signal testing module 204 controls each computer 1 to test each test signal in the test signal sequence of each test item according to the test parameters of the computer type, reads test result data of each test signal in the test signal sequence, and stores the test result data in the preset storage path (e.g., D:\Computer\Test).

The signal testing module 204 further compares each test result data of each test signal with a standard test result of the test signal, so as to determine if the test result data of each test signal is acceptable. For example, supposing the standard test result of the rise time of the voltage signal is [0.1, 0.5], where a unit is one second. If the test result data of the rise time is 0.08 seconds, the signal testing module 204 determines the test result data to not be acceptable.

The signal testing module 204 further determines if all the computers 1 (i.e., all the computer types) have been tested. If any computer has not been tested, the signal testing module 204 tests remaining computers one by one. If all the computers 1 have been tested, the signal testing module 204 collects all the test result data and the determined results, and stores all the test result data and the determined results in the preset storage path.

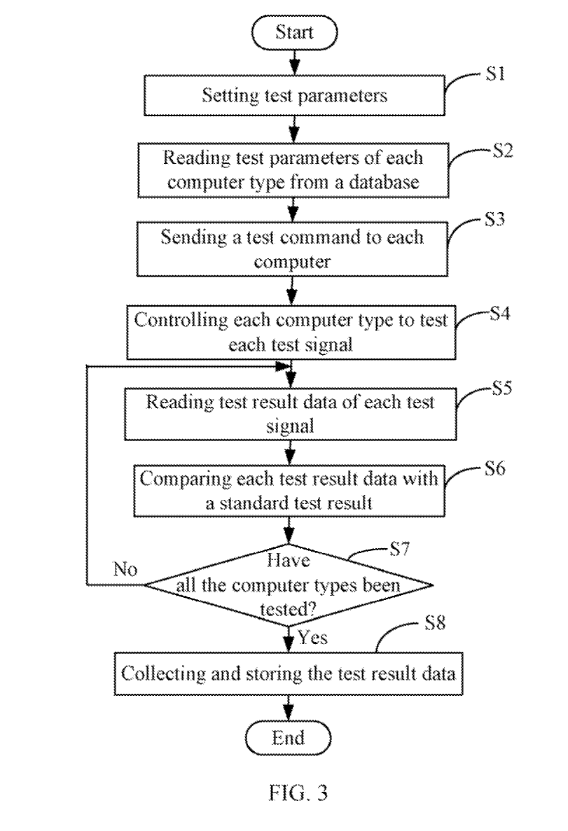

FIG. 3 is a flowchart of one embodiment of a method for testing different computer types. Depending on the embodiment, additional blocks may be added, others removed, and the ordering of the blocks may be changed.

In block S1, the parameter setting module 201 sets test parameters of each computer type of the computers 1 and stores the test parameters in the storage device (e.g., the database 5) of the test server 2.

In block S2, the parameter obtaining module 202 reads test parameters of each computer type of the computers 1 from the database 5.

In block S3, the command sending module 203 sends a test command to each computer 1 according to the test parameters of each computer type. As mentioned above, the test command includes the test items of each computer type, the test signal sequence of each test item, the standard test result of each test signal in the test signal sequence, and the preset storage path to store test result data of each computer type.

In block S4, the signal testing module 204 controls each computer 1 (i.e., each computer type) to test each test signal in the test signal sequence of each test item according to the test parameters of the computer type.

In block S5, the signal testing module 204 reads test result data of each test signal in the test signal sequence, and stores the test result data in the preset storage path (e.g., D: \Computer\Test).

In block S6, the signal testing module 204 compares each test result data of each test signal with a standard test result of the test signal, so as to determine if the test result data of each test signal is acceptable.

In block S7, the signal testing module 204 determines if all the computers 1 (i.e., all the computer types) have been tested. If any computer 1 has not been tested, the procedure returns to block S5. Otherwise, the procedure goes to block S8 if all the computers 1 have been tested. For example, supposing m represents a total number of the computers 1 to be tested, i represents a current number of test. For the purpose of illustration, an initial value of i equals one. If i is less than m, i is evaluated as i+1 (i=i +1), the procedure returns to the block S5. If i is greater than or equal to m, the procedure goes to block S8.

In block S8, the signal testing module 204 collects all the test result data and the determined results, and stores all the test result data and the determined results in the preset storage path.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for testing computer types, the method comprising:
setting test parameters of each of the computer types and storing the test parameters in a storage device of a test server, the test parameters comprising the computer types, test items of each of the computer types, a test signal sequence of each of the test items, a standard test result of each test signal in the test signal sequence, and a preset storage path to store test result data of each of the computer types;
reading test parameters of each of the computer types from the storage device, and sending a test command to each computer according to the test parameters of each of the computer types;
controlling each of the different computer types to test each test signal in the test signal sequence of each test item, and reading test result data of each test signal in the test signal sequence;
comparing each test result data of each test signal with a standard test result of the test signal, so as to determine if the test result data of each test signal is acceptable; and
collecting all the test result data and the determined results if all the computer types have been tested, and storing all the test result data and the determined results in the preset storage path.

2. The method according to claim 1, wherein the number of the computer types is greater than or equal to two.

3. The method according to claim 1, wherein the test items of each of the computer types comprise a central processing unit (CPU), a compact disc read-only memory (CD-ROM), and a modem.

4. The method according to claim 1, wherein the test signals in the test signal sequence comprise a voltage signal, a periodic signal, and a frequency signal.

5. The method according to claim 1, wherein the test command comprises the test items of each of the computer types, the test signal sequence of each test item, the standard test result of each test signal in the test signal sequence, and the preset storage path to store test result data of each of the computer types.

6. A storage medium having stored thereon instructions that, when executed by a processor of a computer, cause the processor to perform a method for testing different computer types, the method comprising:
setting test parameters of each of the computer types and storing the test parameters in a storage device of a test server, the test parameters comprising the computer types, test items of each of the computer types, a test signal sequence of each of the test items, a standard test result of each test signal in the test signal sequence, and a preset storage path to store test result data of each of the computer types;
reading test parameters of each of the computer types from the storage device, and sending a test command to each computer according to the test parameters of each of the computer types;
controlling each of the different computer types to test each test signal in the test signal sequence of each test item, and reading test result data of each test signal in the test signal sequence;
comparing each test result data of each test signal with a standard test result of the test signal, so as to determine if the test result data of each test signal is acceptable; and
collecting all the test result data and the determined results if all the computer types have been tested, and storing all the test result data and the determined results in the preset storage path.

7. The storage medium according to claim 6, wherein the number of the computer types is greater than or equal to two.

8. The storage medium according to claim 6, wherein the test items of each of the computer types comprise a central processing unit (CPU), a compact disc read-only memory (CD-ROM), and a modem.

9. The storage medium according to claim 6, wherein the test signals in the test signal sequence comprise a voltage signal, a periodic signal, and a frequency signal.

10. The storage medium according to claim 6, wherein the test command comprises the test items of each of the computer types, the test signal sequence of each test item, the standard test result of each test signal in the test signal sequence, and the preset storage path to store test result data of each of the computer types.

11. The storage medium according to claim 6, wherein the medium is selected from the group consisting of a hard disk drive, a compact disc, a digital video disc, and a tape drive.

12. A computing system for testing different computer types, comprising:
a parameter setting module operable to set test parameters of each of the computer types and store the test parameters in a storage device of a test server, the test parameters comprising the computer types, test items of each of the computer types, a test signal sequence of each of the test items, a standard test result of each test signal in the test signal sequence, and a preset storage path to store test result data of each of the computer types;
a parameter obtaining module operable to read test parameters of each of the computer types from the storage device;
a command sending module operable to send a test command to each computer according to the test parameters of each of the computer types;
a signal testing module operable to control each of the different computer types to test each test signal in the test signal sequence of each test item, and read test result data of each test signal in the test signal sequence;
the signal testing module further operable to compare each test result data of each test signal with a standard test result of the test signal, so as to determine if the test result data of each test signal is acceptable;
the signal testing module further operable to collect all the test result data and the determined results if all the computer types have been tested, and store all the test result data and the determined results in the preset storage path; and
at least one processor to execute the parameter setting module, the parameter obtaining module, the command sending module, and the signal testing module.

13. The system according to claim 12, wherein the number of the computer types is greater than or equal to two.

14. The system according to claim 12, wherein the test items of each of the computer types comprise a central processing unit (CPU), a compact disc read-only memory (CD-ROM), and a modem.

15. The system according to claim 12, wherein the test signals in the test signal sequence comprise a voltage signal, a periodic signal, and a frequency signal.

16. The system according to claim 12, wherein the test command comprises the test items of each of the computer types, the test signal sequence of each test item, the standard test result of each test signal in the test signal sequence, and the preset storage path to store test result data of each of the computer types.
